(19) United States
(12) Patent Application Publication
(10) Pub. No.: US 2010/0083806 A1
(43) Pub. Date: Apr. 8, 2010

(54) Acoustic Guitar With Resonators Augmenters Disposed Therein

(75) Inventor: Hartley D. Peavey, Meridian, MS (US)

Correspondence Address: GIBSON & DERNIER LLP, 900 ROUTE 9 NORTH, SUITE 504, WOODBRIDGE, NJ, 07095, US

(73) Assignee: PEAVEY ELECTRONICS CORPORATION, Meridian, MS (US)

(21) Appl. No.: 12/244,089

(22) Filed: Oct. 2, 2008

(51) Int. Cl. G10D 3/02

(52) U.S. Cl. 84/294

(57) ABSTRACT

An acoustic guitar includes: a body having a soundboard, a back, and sides defining an interior volume thereof; a neck extending away from the body; a plurality of strings, each stretched from a first end at the body to a second end at a terminal end of the neck; and a plurality of resonant augmenters disposed within the interior volume of the body, each resonant augmenter being coupled at one edge in lever fashion to a mounting plate, the mounting plate being coupled to the soundboard, wherein one or more of the resonant augmenters are sized and shaped to resonate at one or more respective fundamental frequencies.

### BACKGROUND OF THE INVENTION

The present invention relates to an acoustic guitar having one or more resonant augmenters therein, which are operable to improve the resonant characteristics of the guitar.

Acoustic guitars have evolved from the simple stringed instruments of the middle ages. An acoustic guitar includes a hollow body, a neck connected to the body, a head at the opposite end of the neck, and a plurality of strings. The body is usually in a traditional figure-eight shape (which was pioneered in Europe about 500 years ago). The guitar includes a fairly thin soundboard (the front surface of the body) that supports a bridge. The bridge is a structure that engages the strings at one end and acoustically connects them to the body of the guitar (specifically the soundboard) The bridge sits in a bridge saddle and establishes the lower witness point for the strings—the point at one end of the acoustical length of the string. The strings stretch from the bridge, across the fingerboard, to respective adjustable posts on the head. At the junction of the neck and the head, the strings pass over a nut, which is another witness point. Thus, when plucking the open strings, the acoustical length (and tone) of each string is established between the bridge and the nut.

Acoustic guitars employ frets along the fingerboard which are used by a player to change the string length (and thus the pitch) of the string when the player's finger presses the string to the fret and fingerboard.

When an acoustic guitar is tuned to concert pitch, considerable tension is applied to the structure of the guitar. As the strings are plucked, the strings alternately stretch and relax as each travels from a resting position to the outer limits of motion on each side of the resting position. The effect of such string vibration is to alter the tension of the string as a function of time, thus varying the pressure on the bridge and the soundboard to which it is attached. Since this structure is relatively rigid, the vibration of the string causes the soundboard to vibrate (e.g., move up and down) with the string motion and at the same frequency as the string. As the soundboard moves up and down, an air column contained inside the body of the guitar is also activated and resonates at the frequencies of the body and strings. The acoustic guitar is thus a resonant structure, usually with some kind of vent to the outside air—which essentially constitutes a Helmholtz Resonator.

It is generally considered that better guitars tend to be more resonant and have more output volume than less-resonant, cheaper guitars.

An ongoing problem with acoustic guitars has been that they are rarely loud enough to compete with other instruments in an orchestra or even a small ensemble. Percussion, brass, and even woodwind instruments are often substantially louder than an un-amplified, acoustic guitar. There are numerous reasons for this, but a primary reason is that the guitar strings have comparatively small mass and, thus, have a limited ability to affect the vibrational magnitude of the soundboard of the guitar. As a consequence, the air column inside the body of the guitar also resonates with a limited magnitude.

Over the centuries, many different approaches and materials have been tried to improve the acoustic output of the guitar. Most guitar makers are aware that a larger acoustic guitar body produces more resonance and, therefore, is louder than an acoustic guitar with a smaller body. There have been many different body shapes, sizes, and styles, with some claiming that a rounded back is better to reflect the sound than a flat back. Some larger guitars have become popular and are often referred to as dreadnaughts (a term borrowed from early steel battleships of the late 1800s and early 1900s). The dreadnaught guitars are a modification of the traditional figure-eight shape, having decidedly less of a waist and generally being somewhat larger than regular acoustic guitars (i.e., having more interval volume within the body).

At least two manufacturers of electric guitars and basses have tried to utilize a kind of tuning fork to enhance resonance with little success. The tuning fork approach is not able to move any appreciable amount of air and, thus, is not able to substantially improve the audible resonance characteristics of the guitar. In one attempt, an electric bass guitar bridge was constructed using four resonant metal tuning forks (each being tuned to only one frequency) as part of the bridge structure. These tuning forks were part of four individual bridges and, again, did not significantly improve the audible resonance characteristics of the guitar.

In the so-called Dobro guitar design, the soundboard itself has been partially replaced with a metallic resonator in an effort to increase the sound output level of the acoustic guitar.

Despite previous attempts to improve the resonance and sound output of the acoustic guitar, the results heretofore attained have been marginal. It is desirable, therefore, to further improve the resonance characteristics of an acoustic guitar.

### SUMMARY OF THE INVENTION

One of the approaches to implementing the present invention is to provide apparatus inside the guitar (within the interior volume of the body) to enhance the resonant characteristics thereof. More specifically, the guitar is provided with one or more resonant augmenters within the interior volume of the body) to enhance the resonant characteristics of the guitar. Herein the resonant augmenters may also be referred to as augmenters, resonant augmenters, resonators or the like.

As an acoustic guitar is a resonant system, it has specific fundamental resonant frequencies at which the components of the system (e.g., the body, the neck, etc.) resonate at the highest magnitudes. In addition to the fundamental resonant frequencies (at which the highest magnitude resonances occur), the guitar includes a specific range of frequencies that comprise the resonant curve (or resonant peak curve), which is usually a bell-shaped curve. This resonant peak curve results from several contributing factors, such as the internal volume of the body, the shape of the body, the materials of the body, the mass of the strings and the tension of the strings, etc.

In addition to its fundamental resonance and the peak resonance curve, the guitar will resonate somewhat at the frequencies of the vibrating strings, either open or at particular fret positions. Thus, each string (whether open or shortened to a fretted position) will vibrate at a particular frequency—and may also exhibit a bell-shaped frequency response at such a frequency.

Various aspects of the present invention include the use of multiple resonant vanes (resonant augmenters) to mechanically enhance the resonance of the air column inside the guitar body. The resonant vanes are preferably flat, of significant surface area, and are tuned to resonate over a range of frequencies. The resonant vanes are of sufficient surface area to move substantial magnitudes of air inside the guitar, and enhance the resonance of the air column.

In accordance with one or more aspects of the present invention, internal resonant vanes of the proper size, mass, and configuration are disposed within the internal volume of the body of the guitar to enhance the system resonance at one or more of: the peak resonances of the guitar, (ii) a fundamental frequency of vibration of a string or strings, and (iii) one or more harmonics of the fundamental frequency of vibration of the strings or body (e.g., the fifth overtones). More specifically, the internal resonant vanes are designed to increase the magnitude(s) of the resonance(s) at and/or around the top of the bell-shaped curves of the various frequencies of interest.

When the strings of the guitar are plucked, the guitar tends to resonate at one or more fundamental frequencies. Until now, the only thing resonating inside the guitar body has been the air column. The internal resonant structures (augmenters or vanes) inside the guitar are sized, shaped, and positioned within the body such that they are activated by the soundboard just as is the air inside, and such that the internal resonant structures resonate over the desired range of fundamental frequencies (and/or overtones, such as the fifth overtone) of interest. Since the internal augmenters are significantly more massive than air, the resonance will be both longer and stronger than with the internal air column alone.

In accordance with one or more embodiments of the present invention an acoustic guitar includes: a body having a soundboard, a back, and sides defining an interior volume thereof; a neck extending away from the body; a plurality of strings, each stretched from a first end at the body to a second end at a terminal end of the neck; and a plurality of resonant augmenters disposed within the interior volume of the body, each resonant augmenter being coupled at one edge in lever fashion to a mounting plate, the mounting plate being coupled to the soundboard, wherein one or more of the resonant augmenters are sized and shaped to resonate at one or more respective fundamental frequencies.

Other aspects, features, and advantages of the present invention will be apparent to one skilled in the art from the description herein taken in conjunction with the accompanying drawings.

### DESCRIPTION OF THE DRAWINGS

For the purposes of illustration, there are forms shown in the drawings that are presently preferred, it being understood, however, that the invention is not limited to the precise arrangements and instrumentalities shown.

FIG. 1 is a perspective view of a guitar having resonant augmenter structures located in a body thereof in accordance with one or more aspects of the present invention;

FIG. 2 is a perspective cut away view of the guitar of FIG. 1 with the back of the body removed, thereby exposing the resonant augmenter structures;

FIG. 3 is a perspective view of the resonant augmenter structures of FIG. 2;

FIG. 4 is a backside view of the resonant augmenter structures of FIG. 2;

FIG. 5 is an example of a resonance curve of the guitar of FIG. 1;

FIG. 6 is one side view of the resonant augmenter structures of FIG. 2;

FIG. 7 is another side view (orthogonal to FIG. 5) of the resonant augmenter structures of FIG. 2; and

FIG. 8 is a backside view of an alternative design for the resonant augmenter structures.

### DETAILED DESCRIPTION OF THE PREFERRED EMBODIMENTS

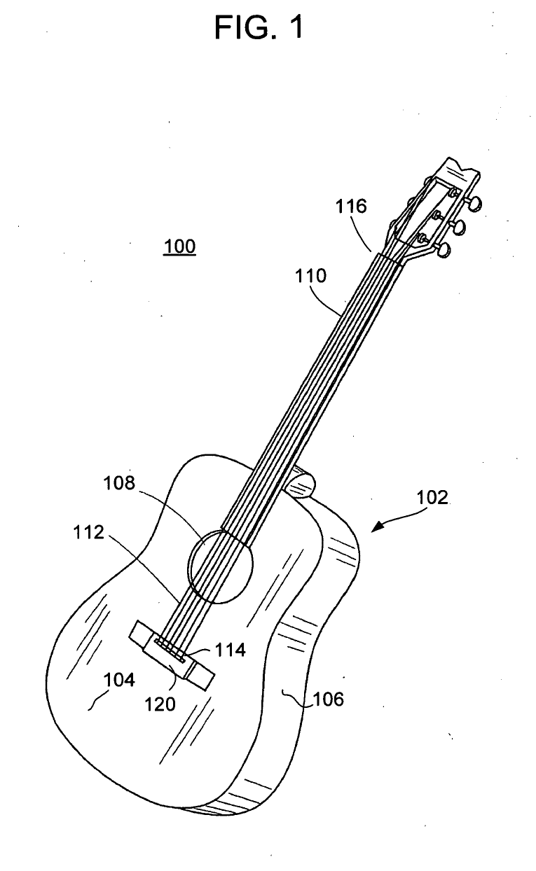

With reference to the drawings, wherein like numerals indicate like elements, there is shown in FIG. 1 a guitar 100 in accordance with one or more embodiments of the present invention. The guitar 100 includes a body 102 having a soundboard 104, a back, and sides 106 defining an interior volume thereof. The soundboard 104 includes an aperture 108 therethrough to permit air to exit and enter the body 102.

The guitar 100 also includes a neck 110 extending away from the body 102, and a plurality of strings 112, each stretched from a first end 114 at the body 102 to a second end 116 at a terminal end of the neck 110. More specifically, the guitar 100 includes a bridge and bridge saddle 120 coupled to the soundboard 104 and operable to connect the plurality of strings 112 at their respective first ends 114 to the body 102.

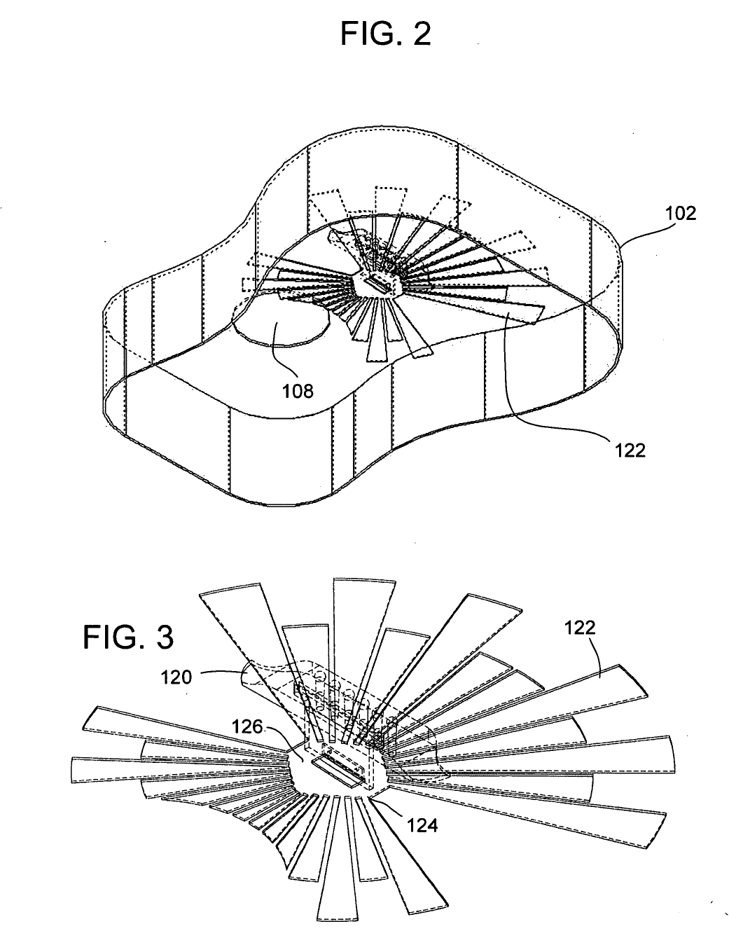

With reference to FIG. 2, a perspective view of the guitar 100 of FIG. 1 is illustrated in which with the back of the body 102 is not shown and permits the viewer to see the interior volume 120 of the body 102 from the rear. The guitar 100 further includes a plurality of resonant augmenters 122 disposed within the interior volume 120 of the body 102.

Each of the resonant augmenters 122 are sized and shaped to resonate at one or more resonant frequencies. Preferably, at least some of the resonant augmenters 122 are sized and shaped to resonate proximate to one or more fundamental resonant frequencies established by at least one of: the size, the shape, and the material of the body 102, and the mass and tension of the strings 112.

In this regard, it is noted that the fundamental frequency of a cavity with an opening may be expressed as follows:

A×(opening area/(cavity vol.×opening length))^{1/2},

where A is the speed of sound divided by 2 times pi.

The fundamental frequency of a tensioned string may be expressed as follows:

(((tension×length)/(mass))^{1/2})/(2×length)

It is understood that the one or more fundamental resonant frequencies, while primarily being established by the body 102, may also be defined by other structures and materials, such as the neck 110. In alternative configurations, at least one of the resonant augmenters 122 may be sized and shaped to resonate at one or more fundamental frequencies established by at least one of the strings 112. For example, the strings 110 may include bass strings (e.g., the low E, A, and D strings) and other, higher pitched strings. In one or more embodiments of the invention, the resonant augmenters 122 may be sized and shaped to resonate at the fundamental frequency (or frequencies) of only one or more of the bass strings 110. In such a configuration, one or more further resonant augmenters 122 may be sized and shaped to resonate at one or more overtones (such as a fifth overtone) of the fundamental frequency established by the string 110. (This has been found desirable as the acoustic characteristics of the guitar 110 are generally based on the pentatonic scale, i.e., perfect fifth overtones.)

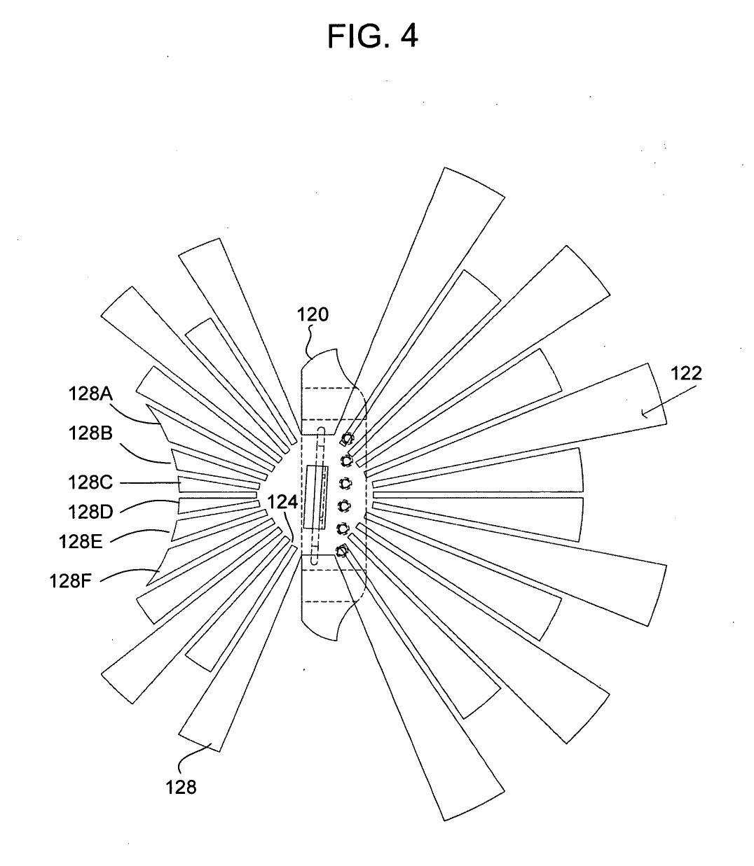

Reference is now made to FIGS. 3-4. FIG. 3 is an enlarged perspective view of the resonant augmenters 122 of the guitar 100. FIG. 4 is an enlarged back-side view of the resonant augmenters 122 of the guitar 100. The illustration includes only the detail of the resonant augmenters 122 themselves, the structure of the bridge saddle 120, and in the case of FIG. 3, a connecting structure (spacer), which will be discussed in more detail below. The plurality of resonant augmenters 122 are each substantially planar and include a surface area of sufficient magnitude to: (i) receive acoustic energy from the soundboard 104 and strings 110; and (ii) move a sufficient amount of air, and increase a magnitude of the acoustic energy within, the body 102 at the one or more resonant frequencies thereof. In this regard, each resonant augmenter 122 is coupled at one edge 124 in lever fashion to a mounting plate 126. The mounting plate 126 is coupled to the soundboard 104 through the bridge saddle 120.

The plurality of resonant augmenters 122 extend radially from the mounting plate 126 in different directions, generally in the form of a fan arrangement. One or more of the resonant augmenters 122 may have differing lengths dependent on the frequency at which they resonate. To improve the resonant characteristics of the resonant augmenters 122, each may include lateral edges that taper outward from the edge 124 at the plate 126 toward a terminal edge 128 thereof. The resonant augmenters 122 may be formed from a relatively thin material having predictable and stable resonant characteristics, such as metal, plastic, fiber, and/or wood materials.

The larger resonant augmenters 122 may be sized and shaped to resonate at one or more fundamental frequencies, such as the frequency or frequencies of a particular string (preferably a lower pitch string), or proximate to a peak resonant frequency of the guitar 100. Each of the resonant augmenters 122 may be substantially planar. Each of the resonant augmenters 122 may include a surface area of sufficient magnitude to receive acoustic energy from the soundboard 104 (and/or other structures of the guitar 100) and resonate at the desired frequency or frequencies.

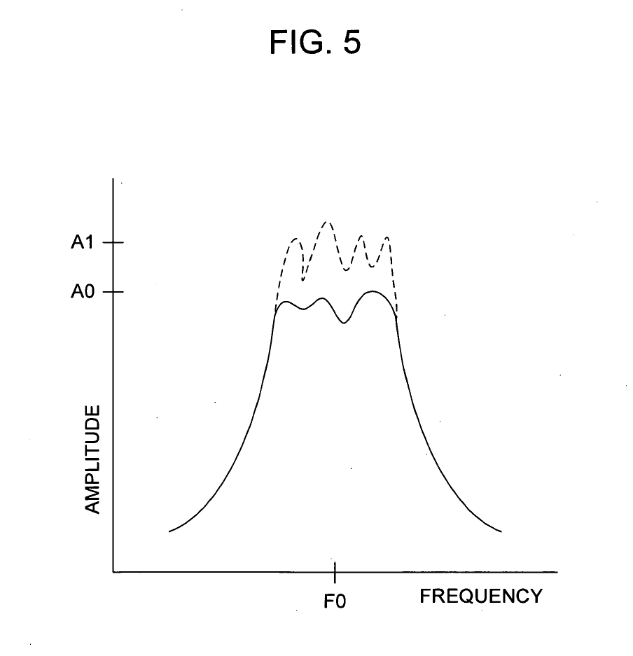

As best seen in FIG. 5, a peak resonance curve of the guitar 100 may be bell-shaped, having a range of peak amplitudes, A, around a fundamental resonance frequency, F0. Without one or more resonant augmenters 122 tuned to one or more desired resonance frequencies of the guitar 100, the amplitude of the resonance around frequency F0 of the guitar 100 is at about A0. With one or more resonant augmenters 122 tuned to one or more frequencies, however, the amplitude of the resonance around frequency F0 of the guitar is at about Al, a significantly higher level. Indeed, one or more of the resonant augmenters 122 are sized and shaped to have sufficient surface area to resonate at the resonant frequency or frequencies of the guitar 100, while moving a sufficient amount of air within the guitar 100 to increase the amplitude of the resonance around the resonant frequency F0.

As previously discussed, in alternative configurations, at least one of the resonant augmenters 122 may be sized and shaped to resonate at one or more fundamental frequencies established by at least one of the strings 112. The resonance characteristic of a particular string (as established in part by its acoustic length) may also be considered bell-shaped as in FIG. 5. Thus, with one or more resonant augmenters 122 tuned to such frequency or frequencies of interest, the amplitude of the resonance around the fundamental frequency (F0) of the particular string 110 may be at a significantly higher level. Additionally, one or more further resonant augmenters 122 may be sized and shaped to resonate at one or more overtones (or harmonics, sub-harmonics), such as the fifth overtone, of the fundamental frequency or frequencies established by the string 112. Thus, the amplitudes of the resonances at such overtones may also be at significantly higher levels.

The resonant augmenters 122 may be designed to resonate over a fairly narrow range of frequencies when activated. The resonant augmenters 122 have significant surface area so as to receive energy from the vibrating soundboard 104 (both as a sound pressure wave off the back side of soundboard 104 and additionally from other sources of mechanical or acoustic energy within the body 102). The resonance of the resonant augmenters 122 increases the total resonance of the guitar 100 and maximizes the loudness of the guitar 100 by mechanically reinforcing the resonance of the air column inside the body 102.

The particular size and shape of the resonant augmenters 122 may vary as illustrated in FIGS. 2-4. The resonance characteristics of the resonant augmenters 122 are a function of the dimensions, the density, and the elastic modulus of the material(s) from which they are manufactured. The resonance frequency, f, may be computed according to the following equation:

$$f = k \sqrt{\frac{E}{ρ}} \qquad [$$

where the physical dimensions of the resonant augmenter 122 are represented by k, the elastic modulus of the resonant augmenter is represented by E, and the density ρ.

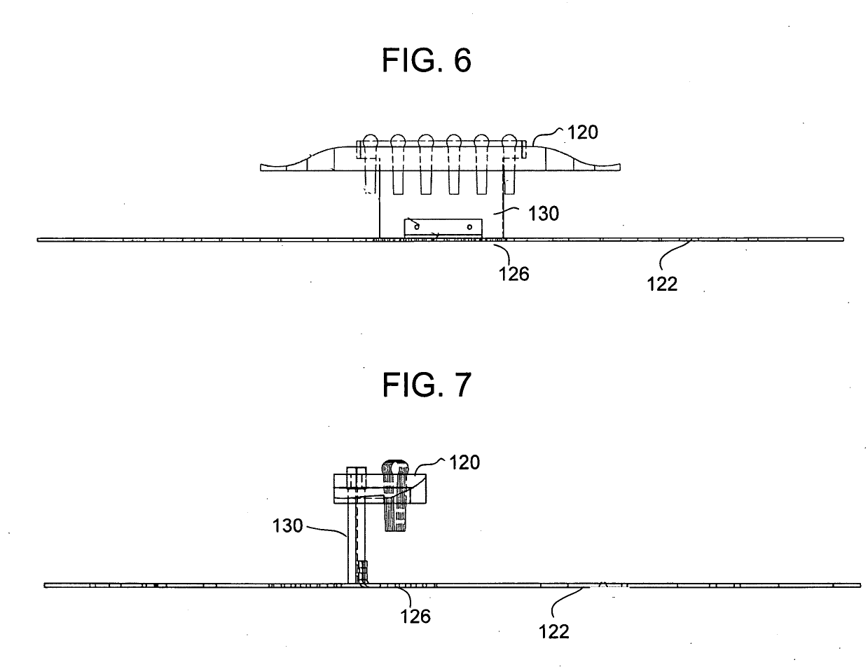

As best seen in the side views of the resonant augmenters 122 in FIGS. 6-7, the resonant augmenters 122 are preferably disposed in co-planar relationship to one another. A spacer 130 is disposed between, and is operable to connect, the bridge saddle 120 and the mounting plate 126. More particularly, the spacer 130 extends transversely from a backside of the bridge saddle 120 to the mounting plate 126 and suspends the plurality of resonant augmenters 122 within the body 102 at a desirable depth. Indeed, the length of the spacer 130 establishes such depth. The spacer 130 may be sized and shaped such that the plurality of resonant augmenters 122 are substantially parallel to the soundboard 104. In other configurations, one or more of the resonant augmenters 122 may not be parallel to the soundboard 104. Additionally or alternatively, the spacer 130 may be sized and shaped such that the plurality of resonant augmenters 122 are located closer to the soundboard 104 than to the back of the body.

It is desirable to size and shape the resonant augmenters 122 to minimize interference with the passage of the sound pressure wave of the acoustic air column within the body 102 through the aperture 108, while also maintaining sufficient surface area of each resonant augmenter 122 to move a substantial amount of air. In order to minimize the interference with the passage of the sound pressure wave, and maintain individual resonance characteristics of each resonant augmenter 122, the resonant augmenters 122 are circumferentially spaced apart from one another to permit air to flow therebetween. The configuration of the resonant augmenters illustrated in this and other embodiments herein are somewhat similar to the blades of a fan.

In the example implementation shown, each of the resonant augmenters 122 includes an opposite edge 128 to the edge 124 coupled to the mounting plate 126. Some of the plurality of resonant augmenters 122 extend from the mounting plate 126 toward the aperture 108 of the soundboard 104. The opposite edges 128 of these resonant augmenters 122 may be concave curvilinear, such as edges 128A, 128B, 128C, 128D, 128E, 128F. The concave curvilinear edges 128 of the resonant augmenters 122 may define a circular shape that is complementary to the aperture 108, such that the resonant augmenters 122 do not obstruct the aperture 108 and the acoustic air column may pass uninterrupted.

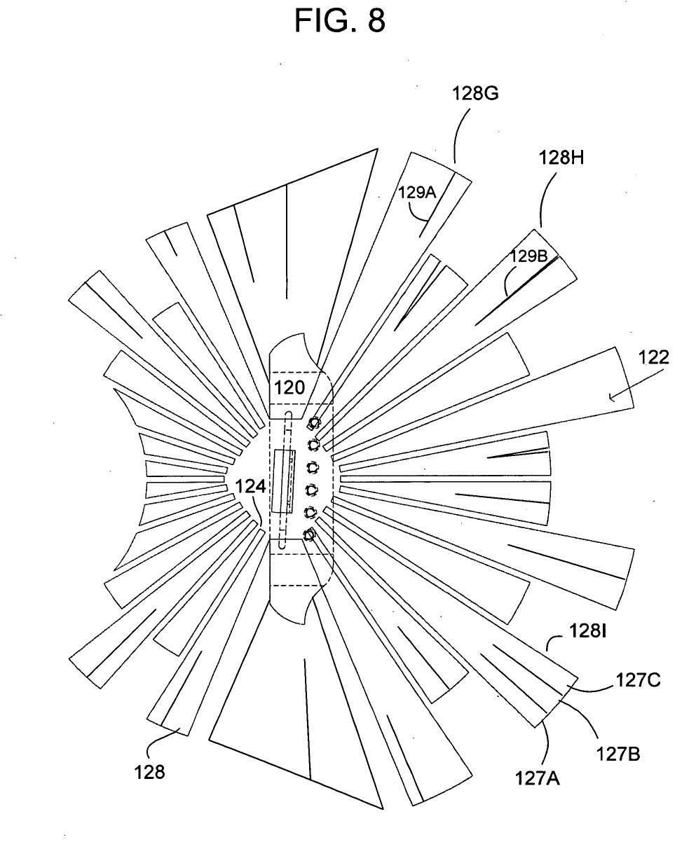

With reference to FIG. 8, alternative configurations for the resonant augmenters 122 are illustrated in which at least one of the augmenters (such as augmenters 128G, 128H, 128I) includes at least one slot 129 (such as slots 129A, 129B). The slots 129 create multiple segments, such as segments 127A, 127B, 127C of augmenter 128I, where the multiple segments 127 cause the resonant augmenter to resonate over a range of fundamental frequencies.

Although the invention herein has been described with reference to particular embodiments, it is to be understood that these embodiments are merely illustrative of the principles and applications of the present invention. It is therefore to be understood that numerous modifications may be made to the illustrative embodiments and that other embodiments may be devised without departing from the spirit and scope of the present invention as defined by the appended claims.

1. An acoustic guitar, comprising:
a body having a soundboard, a back, and sides defining an interior volume thereof;
a neck extending away from the body;
a plurality of strings, each stretched from a first end at the body to a second end at a terminal end of the neck; and
a plurality of resonant augmenters disposed within the interior volume of the body, each resonant augmenter being coupled at one edge in lever fashion to a mounting plate, the mounting plate being coupled to the soundboard,
wherein one or more of the resonant augmenters are sized and shaped to resonate at one or more respective fundamental frequencies.

2. The acoustic guitar of claim 1, wherein:
the soundboard includes an aperture therethrough to permit air to exit and enter the body; and
the plurality of resonant augmenters extend from the mounting plate toward the aperture without obstructing the aperture.

3. The acoustic guitar of claim 1, wherein at least one of the resonant augmenters is sized and shaped to resonate proximate to a fundamental resonant frequency established by at least one of: a size and shape of the body, materials used to form the body, a mass of the strings, a tension of the strings, and an internal volume of air in the body.

4. The acoustic guitar of claim 1, wherein at least one of the resonant augmenters is sized and shaped to resonate at one or more fundamental frequencies established by at least one string.

5. The acoustic guitar of claim 4, wherein at least one of the resonant augmenters is sized and shaped to resonate substantially at a fifth overtone of the one or more fundamental frequencies established by the at least one of the string.

6. The acoustic guitar of claim 4, wherein:
the strings include bass strings and other, higher pitched strings; and
the resonant augmenters are sized and shaped to resonate at fundamental frequencies of only one or more of the bass strings.

7. The acoustic guitar of claim 6, wherein the bass strings are the low E, A, and D strings.

8. The acoustic guitar of claim 1, wherein one or more of the resonant augmenters includes one or more slots such that the one or more of the resonant augmenters resonate over a range of fundamental frequencies.

9. The acoustic guitar of claim 1, wherein the plurality of resonant augmenters are substantially parallel to the soundboard.

10. The acoustic guitar of claim 1, wherein the plurality of resonant augmenters are located closer to the soundboard than to the back of the body.

11. The acoustic guitar of claim 1, further comprising:
a bridge saddle coupled to the soundboard and operable to connect the plurality of strings at their respective first ends to the body; and
a spacer disposed between, and operable to connect, the bridge saddle and the mounting plate.

12. The acoustic guitar of claim 11, wherein the spacer extends transversely from a backside of the bridge saddle to the mounting plate and suspends the plurality of resonant augmenters within the body.

13. The acoustic guitar of claim 1, wherein the plurality of resonant augmenters extend radially from the mounting plate in different directions.

14. The acoustic guitar of claim 1, wherein the plurality of resonant augmenters include differing lengths dependent on the one or more frequencies over which they resonate.

15. The acoustic guitar of claim 13, wherein:
a set of the plurality of resonant augmenters extend from the mounting plate toward an aperture of the soundboard; and
respective terminal edges of the set of resonant augmenters are contoured to complement a curvature of the aperture.

16. The acoustic guitar of claim 1, wherein lateral edges of each resonant augmenter tapers outward from the one edge at the mounting plate toward a terminal edge thereof.

17. The acoustic guitar of claim 1, wherein the plurality of resonant augmenters each include a surface area of sufficient magnitude to: (i) receive acoustic energy from the soundboard and strings; and (ii) move a sufficient amount of air, and increase a magnitude of the acoustic energy within, the body at the resonant frequencies thereof.

18. The acoustic guitar of claim 1, wherein the plurality of resonant augmenters are each substantially planar.

19. An acoustic guitar, comprising:
a body having a soundboard, a back, and sides defining an interior volume thereof;
a neck extending away from the body;
a plurality of strings, each stretched from a first end at the body to a second end at a terminal end of the neck; and
a plurality of resonant augmenters disposed within the interior volume of the body, wherein:
each resonant augmenter is coupled at one edge in lever fashion to a mounting plate, the mounting plate being coupled to the soundboard, and
one or more of the resonant augmenters includes one or more slots such that the one or more of the resonant augmenters resonate over a range of fundamental frequencies.

20. The acoustic guitar of claim 19, wherein the plurality of resonant augmenters extend radially from the mounting plate in different directions.

21. The acoustic guitar of claim 19, wherein the plurality of resonant augmenters include differing lengths dependent on the frequency at which they resonate.

22. The acoustic guitar of claim 19, wherein lateral edges of each resonant augmenter tapers outward from the one edge at the mounting plate toward a terminal edge thereof.

23. The acoustic guitar of claim 19, wherein the plurality of resonant augmenters each include a surface area of sufficient magnitude to: (i) receive acoustic energy from the soundboard and strings; and (ii) move a sufficient amount of air, and increase a magnitude of the acoustic energy within, the body at the resonant frequencies thereof.

24. The acoustic guitar of claim 23, wherein the plurality of resonant augmenters are each substantially planar.
